(19) United States
(12) Patent Application Publication
(10) Pub. No.: US 2022/0374581 A1
(43) Pub. Date: Nov. 24, 2022

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Yoshihisa MATSUO, Kanagawa (JP)

(73) Assignee: FUJIFILM Business Innovation Corp., Tokyo (JP)

(21) Appl. No.: 17/464,787

(22) Filed: Sep. 2, 2021

(30) Foreign Application Priority Data
May 24, 2021 (JP) 2021-087230

(51) Int. Cl. G06F 40/106

(52) U.S. Cl. CPC G06F 40/106

(57) ABSTRACT

An information processing apparatus includes a processor configured to: maintain a work area in which an instruction image that receives an instruction from a user is placed, the work area being an area larger than an area to be displayed on an operation screen for receiving an operation performed by a user; and when a specific work area is designated, display a whole image that shows an entirety of the specific work area on the operation screen.

### CROSS-REFERENCE TO RELATED APPLICATIONS

This application is based on and claims priority under 35 USC 119 from Japanese Patent Application No. 2021-087230 filed May 24, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2018-28748 describes the configuration that at the time of interrupting a work screen for document related works, generates a capture image representing the work screen by acquiring the work screen being displayed and displays the capture image before displaying an actual work screen as information representing a work screen that will be displayed at the time of resuming the work.

### SUMMARY

It is conceivable that in the case where there is a plurality of independent work areas, a preview image may be displayed as information representing one of the work areas in order to check which work area is the work area a user intends to work with. In the case where the content or arrangement of an instruction image in the work area plays a certain role, there is a need to reflect the accurate appearance or position of the instruction image. The work area is, for example, an area larger than the display range on a screen. However, when simply displaying the capture image of the work area that has been displayed on the screen as the preview image, the part of the work area, which is not displayed on the screen, will not be displayed.

Aspects of non-limiting embodiments of the present disclosure relate to, in the case where the work area is larger than an area being displayed on the screen, a technique that allows a user to check the state of the entire work area irrespective of the area being displayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: maintain a work area in which an instruction image that receives an instruction from a user is placed, the work area being an area larger than an area to be displayed on an operation screen for receiving an operation performed by a user; and when a specific work area is designated, display a whole image that shows an entirety of the specific work area on the operation screen.

### BRIEF DESCRIPTION OF THE DRAWINGS

An exemplary embodiment of the present disclosure will be described in detail based on the following figures, wherein:

FIG. 1 is a block diagram illustrating an example of hardware configuration of an image display apparatus according to a present exemplary embodiment;

FIG. 2 is a diagram illustrating an example of a work area to which the present exemplary embodiment is applied;

FIG. 3 is a diagram illustrating an example of display of an operation screen to which the present exemplary embodiment is applied;

FIG. 4 is a block diagram illustrating an example of functional configuration of an image display apparatus according to the present exemplary embodiment;

FIG. 5 is a flowchart illustrating process steps for generating a whole image to which the present exemplary embodiment is applied;

FIG. 6 is a table illustrating an example of identification information of partial images to which the present exemplary embodiment is applied;

FIG. 7 is a diagram illustrating an example of relationship between the whole image and the partial images to which the present exemplary embodiment is applied;

FIG. 8 is a flowchart illustrating process steps for acquiring the partial image to which the present exemplary embodiment is applied;

FIG. 9A is a diagram illustrating an example of a display on an operation screen to which the present exemplary embodiment is applied, the example illustrating the state before changing a display mode of an icon;

FIG. 9B is a diagram illustrating an example of the display on the operation screen to which the present exemplary embodiment is applied, the example illustrating the state after changing the display mode of the icon;

FIG. 10A is a diagram illustrating an example of the display on the operation screen to which the present exemplary embodiment is applied, the example illustrating the state where in a specific work area, a preview screen of another work area, which is different from the specific work area, is displayed;

FIG. 10B is a diagram illustrating an example of the display on the operation screen to which the present exemplary embodiment is applied, the example illustrating the state where another work area is displayed;

FIG. 11A is a diagram illustrating an example of the preview screen to which the present exemplary embodiment is applied, the example illustrating the state where the whole image is displayed in one screen; and

FIG. 11B is a diagram illustrating an example of the preview screen to which the present exemplary embodiment is applied, the example illustrating the state where an enlarged whole image is displayed.

### DETAILED DESCRIPTION

Hereinafter, an exemplary embodiment of the present disclosure is described with reference to the attached drawings.

Hardware Configuration of Image Display Apparatus 1

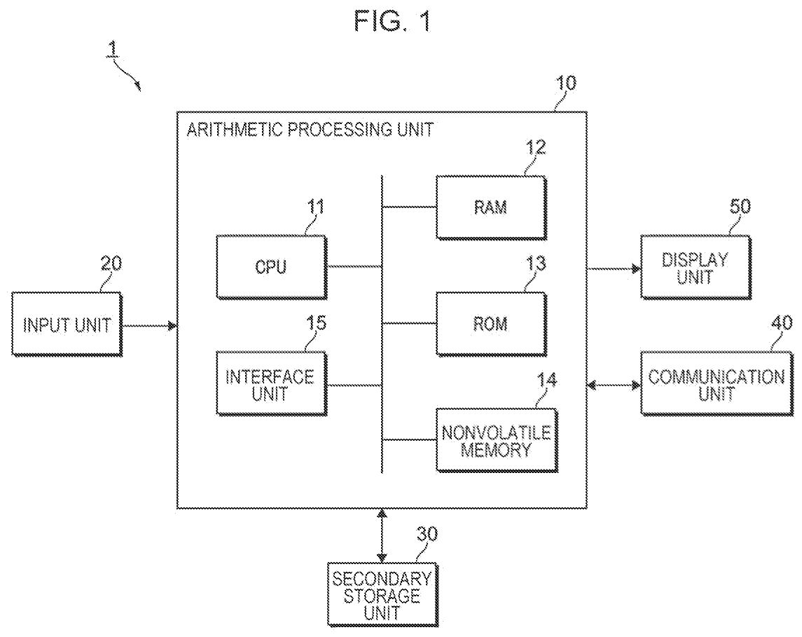

FIG. 1 is a block diagram illustrating an example of hardware configuration of an image display apparatus 1 according to the present exemplary embodiment.

As illustrated in FIG. 1, the image display apparatus 1 according to the present exemplary embodiment includes an arithmetic processing unit 10 that functions as an example of an information processing apparatus and performs a digital arithmetic process in accordance with a predetermined process program at the time of screen display, an input unit 20 that receives an inputting operation from a user, a secondary storage unit 30 realized by a hard disk drive (HDD), a communication unit 40 that transmits and receives data via a network, a display unit 50 including a liquid crystal display, an organic electro-luminescence (EL) display panel, or the like, which displays an image, text information, or the like for a user.

The arithmetic processing unit 10 includes a central processing unit (CPU) 11 that controls the entirety of the apparatus, which serves as an example of a processor, a random access memory (RAM) 12 that is used as a work memory of the CPU 11 or the like, and a read only memory (ROM) 13 in which an image display process program and the like, which are executed by the CPU 11, are stored. The arithmetic processing unit 10 further includes a nonvolatile memory 14 that is rewritable and can retain data even when a power supply stops and an interface unit 15 that controls the respective units connected to the arithmetic processing unit 10, such as the input unit 20 and the like. The nonvolatile memory 14 includes, for example, a SRAM backed up by a battery, a flash memory, or the like and stores image information such as a thumbnail image (which will be described below) to be displayed on the display unit 50. The secondary storage unit 30 stores therein, in addition to image data and the like, the image display process program which is executed by the arithmetic processing unit 10. Each process of the image display apparatus 1 of the present exemplary embodiment is performed when the image display process program stored in the secondary storage unit 30 is loaded into the arithmetic processing unit 10.

Here, programs to be executed by the CPU 11, which serves as an example of a processor, are supplied to the arithmetic processing unit 10 in such a way that the programs are stored in a computer readable recording medium such as a magnetic recording medium (magnetic tape, magnetic disk, or the like), an optical recording medium (optical disk or the like), a magneto-optical recording medium, a semiconductor memory, or the like. Alternatively, the programs to be executed by the CPU 11 may be downloaded to the image display apparatus 1 using a communication means such as the Internet or the like.

In the present exemplary embodiment, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the present exemplary embodiment, the term “processor” is broad enough to encompass one processor or plural processors in collaboration which are located physically apart from each other but may work cooperatively. The order of operations of the processor is not limited to one described in the present exemplary embodiment and may be changed.

The input unit 20 is a device that a user uses to input an operation, such as a pointing device or the like.

For example, in the case where the input unit 20 is a mouse or the like, a position on a screen of the display unit 50, an image displayed on the screen, or the like may be designated when a user performs a moving operation of a cursor or a clicking operation.

In the case where the input unit 20 is a touch panel or the like, a position on the screen or an image displayed on the screen may be designated when a user performs an operation of touching a touch panel using a finger or the like or performs an operation of keeping the finger or the like in contact with the touch panel longer than a predetermined time period. Note that in this case, the input unit 20 and the display unit 50 are formed as a single body.

In addition to the device such as the pointing device and the like described above, a keyboard or the like for a key inputting operation may also be included as the input unit 20.

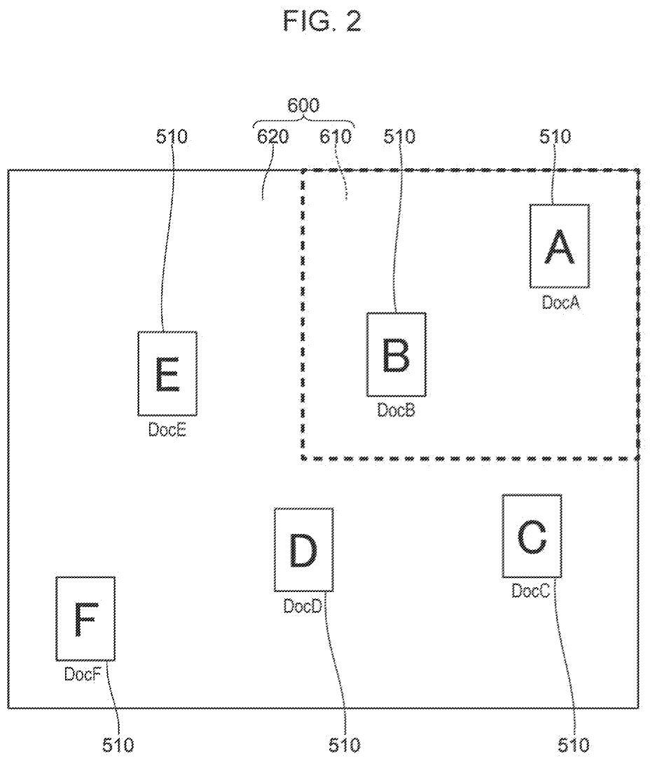

FIG. 2 is a diagram illustrating an example of a work area 600 to which a present exemplary embodiment is applied.

The work area 600 to which the present exemplary embodiment is applied is a work area in a so-called file handling software and is an area larger than an area displayed on one screen on the display unit 50 without scrolling or the like. This file handling software is software that computerizes and manages document data and has capability of promoting a consolidated management of paper and electronic data. The work area 600 is an area in which icons 510 and the like are placed, and the icon 510 is an example of an instruction image that receives an instruction for a document from a user. Depending on the arrangement of the icons 510 and the like, the area size of the work area 600 changes. Note that the document may include an image in addition to texts or may only include one or more images and include no text.

Of the work area 600, an area which is actually displayed on the display unit 50 is referred to as a display area 610, and an area which is actually not displayed on the display unit 50 is referred to as a non-display area 620. In the work area 600, “which area becomes the display area 610” or “which area becomes the non-display area 620” depends on a user's operation such as, for example, a scrolling operation.

The icons 510 are instruction images, each of which represents a different function such as a program function or the like by using a pictorial symbol and receives an instruction for a document from a user. In the example illustrated in FIG. 2, as an example of the icon 510, a thumbnail image is illustrated for checking at least part of the content of each document managed by the file handling software. For example, in the case where a corresponding document is image data, the thumbnail image is displayed as an image obtained by simply reducing an original image. In the case where a corresponding document is document data including a plurality of pages, a representative page such as the first page or the like may be displayed as a reduced image. The icon 510 displayed a thumbnail image functions as an icon for opening a corresponding document.

Although it is not illustrated, in the work area 600, in addition to the icons 510, a tray icon for selecting a tray to be used for delivery and receipt of an electronic document between a user and a third party and a folder icon for selecting a folder to be used for storing an electronic document may be placed.

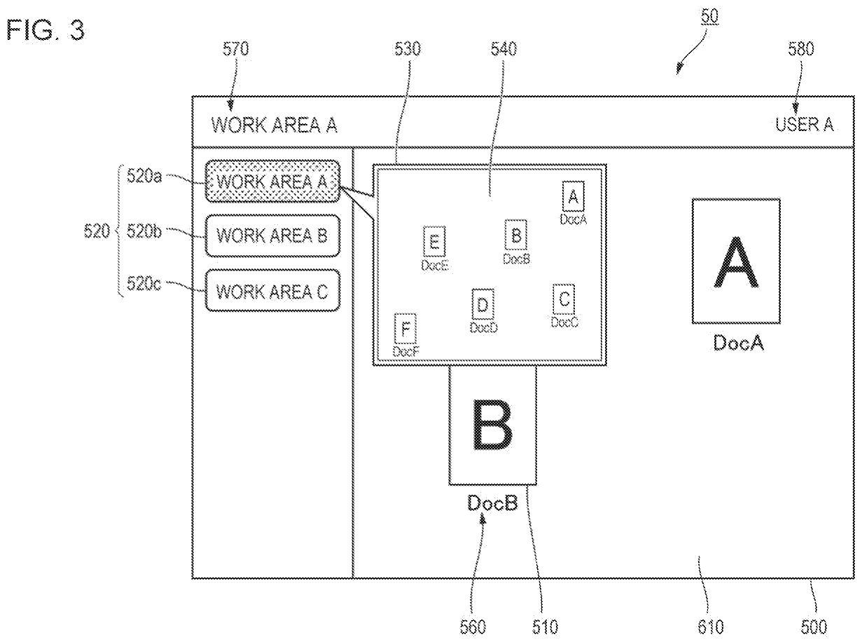

FIG. 3 is a diagram illustrating an example of an operation screen 500 to which a present exemplary embodiment is applied.

The display unit 50 includes the operation screen 500 that is a screen for receiving an operation performed by a user. In this operation screen 500, in addition to the display area 610, a switch button image 520 to receive an operation of switching the work area to be displayed, a preview screen 530 that shows another work area without changing the display area 610 which is actually being displayed, and a whole image 540 that shows the entirety of a specific work area are displayed. The operation screen 500 may further display a text 560 such as a name or the like of a document or a function corresponding to the icon 510, a work area name 570 of the work area 600 of the display area 610 that is actually being displayed, and a username 580 of a current logged in user. The operation screen 500 may also display a scroll image that receives a scrolling operation performed by a user and shows, of the work area 600, “which area is the display area 610”.

The switch button image 520 (520a, 520b, and 520c) is a button image that receives an operation of switching the work area 600 to be displayed on the operation screen 500. For example, in the case where a plurality of separate independent work areas 600 is maintain, the switch button image 520 is used to switch between these work areas 600.

The preview image 530 is a screen that shows a work area that is not displayed on the operation screen 500 irrespective of the display area 610 that is actually being displayed. The preview screen 530 displays the whole image 540 that shows the entirety of the work area 600 corresponding to one switch button image 520 designated by a user.

The operation screen 500 may further display, in addition to the icons 510, a tool bar or the like, which is not illustrated. The tool bar is a collection of instruction parts prepared in order to simplify operations of a user for an electronic document. Operations for an electronic document include operations of saving, printing, rotating, searching, and encrypting of the electronic document, an operation that combines two or more electronic documents, and the like.

Functional Configuration of Image Display Apparatus 1

Next, the functional configuration of the image display apparatus 1 is described.

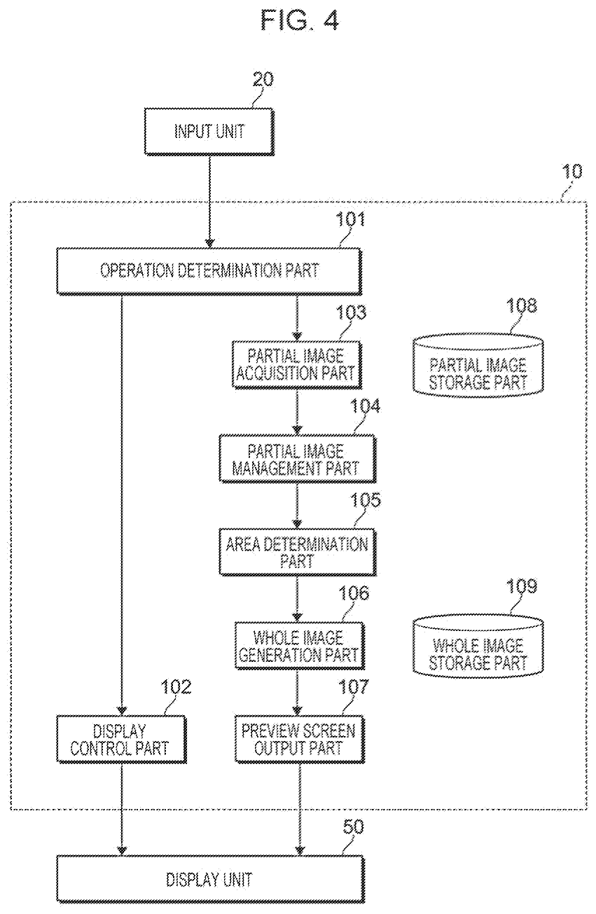

FIG. 4 is a block diagram illustrating an example of the functional configuration of the image display apparatus 1 according to the present exemplary embodiment. As illustrated in FIG. 4, the image display apparatus 1 includes an operation determination part 101, a display control part 102, a partial image acquisition part 103, a partial image management part 104, an area determination part 105, a whole image generation part 106, a preview screen output part 107, a partial image storage part 108, and a whole image storage part 109, which are realized in the arithmetic processing unit 10 (see FIG. 1).

The operation determination part 101 determines whether or not a user operation is performed on the operation screen 500 (see FIG. 3) via the input unit 20. The user operation is, for example, an operation of designating an image, one of various icons, a position, or the like on the operation screen 500, a scrolling operation, a key inputting operation, or the like.

Based on the content of the determination made by the operation determination part 101, the display control part 102 controls the mode or position of a displayed item, such as the icon 510, the switch button image 520, the work area name 570, the username 580 (see FIG. 3), or the like.

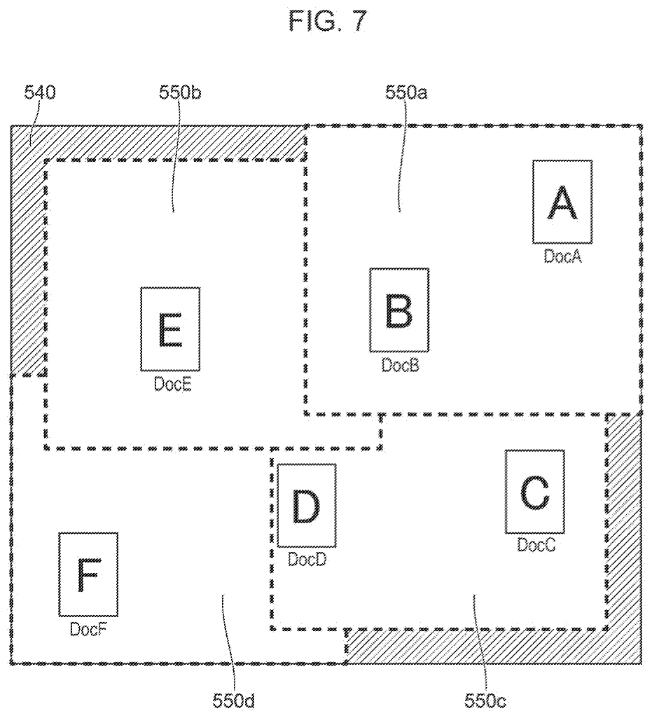

Based on the content of the determination made by the operation determination part 101, in the case where an operation performed by a user satisfies a predetermined condition, the partial image acquisition part 103 acquires a partial image 550 (550a to 550d, see FIG. 7) that shows the display area 610 currently being displayed on the operation screen 500. More specifically, the partial image acquisition part 103 acquires the partial image 550 when an operation of changing the display mode of the icon 510 is performed by a user or when an operation of stopping the display of the work area 600, which is currently being displayed on the operation screen 500, is performed by a user. Changes in the display mode of an icon 510 include, for example, an addition or deletion of the icon 510, a change in the display position of the icon 510 in the work area 600, a change in the appearance of the icon 510, and the like. Operations of stopping the display of the work area 600 include, for example, an operation of selecting the switch button image 520, an operation of ending a program that displays the operation screen 500, and the like.

The partial image acquisition part 103 may acquire partial image generation information that distinguishes each of the partial images 550, and the partial image generation information is information to be used when the partial image 550 is generated. The partial image generation information is, for example, text information relating to the number of the icons 510, the appearance of the icon 510, the display position of the icon 510, or the like in the partial image 550.

The partial image management part 104 manages, for each work area, the partial image 550 or the partial image generation information, which is newly acquired by the partial image acquisition part 103. More specifically, the partial image management part 104 manages a plurality of partial images 550 or the partial image generation information acquired from one work area 600 based on the date and time of acquisition, an image ID, position information such as a coordinate in the work area 600 or the like, or identification information such as a user ID or the like.

The area determination part 105 acquires the area size of the work area 600 that is changed in response to the arrangement of the icon 510 or the like and determines whether or not there is the partial image 550 in the inside of the acquired area size. More specifically, the area determination part 105 determines whether or not the work area 600 whose area size is changed in response to the latest user's operation includes part of the work area 600 shown by the partial image 550 managed by the partial image management part 104. For example, in the case where a certain icon 510 is deleted and the area size of the work area 600 is reduced, the area determination part 105 determines that, based on the coordinate, the partial image 550 showing an area that becomes outside the latest work area 600 is not in the inside of the acquired area size.

The whole image generation part 106 reads out, from the partial image storage part 108, the partial image 550 that is determined by the area determination part 105 as being present in the inside of the area size or the partial image generation information and generates a whole image 540 that shows the entirety of the work area 600 whose area size has been changed. More specifically, the whole image generation part 106 generates a new whole image 540 when the partial image acquisition part 103 acquires the partial image 550 or the partial image generation information. For example, the whole image generation part 106 forms the whole image 540 by combining the partial images 550. The whole image generation part 106 may determine whether or not the partial image 550 is incorporated in every part of the whole image 540 and generate the whole image 540 by using the background of the work area 600 in the area where no partial image 550 is acquired.

The preview screen output part 107 reads out the whole image 540 from the whole image storage part 109 based on the determination of the operation determination part 101, which is that the switch button image 520 is designated. The preview screen output part 107 outputs, to the display unit 50, the preview screen 530 showing the entirety of the work area 600 that corresponds to the switch button image 520 that receives an instruction from a user without newly starting the program. The preview screen 530 is displayed in such a way that the preview screen 530 is associated with the switch button image 520.

The partial image storage part 108 stores therein the partial image 550 or the partial image generation information that are acquired by the partial image acquisition part 103. The partial image storage part 108 is realized by the nonvolatile memory 14.

The whole image storage part 109 acquires and stores therein the whole image 540 generated by the whole image generation part 106. The whole image storage part 109 is realized by the nonvolatile memory 14.

Generation of Whole Image 540 Using Partial Images 550

Next, a generation process of the whole image 540 is described with reference to FIG. 4 to FIG. 7. Here, an example is described using a case where the partial images 550 are acquired.

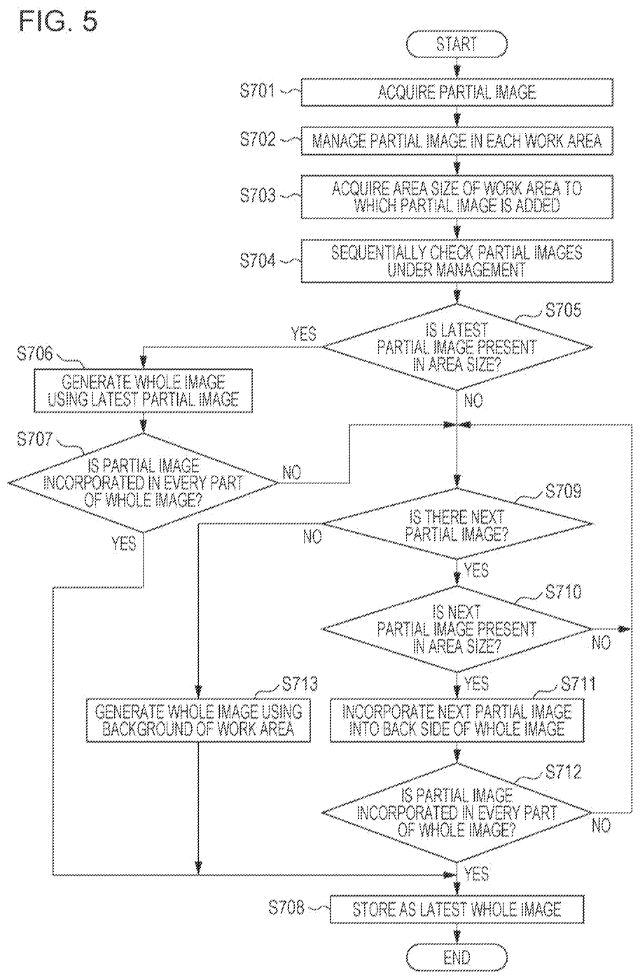

FIG. 5 is a flowchart illustrating process steps for generating the whole image 540 to which the present exemplary embodiment is applied.

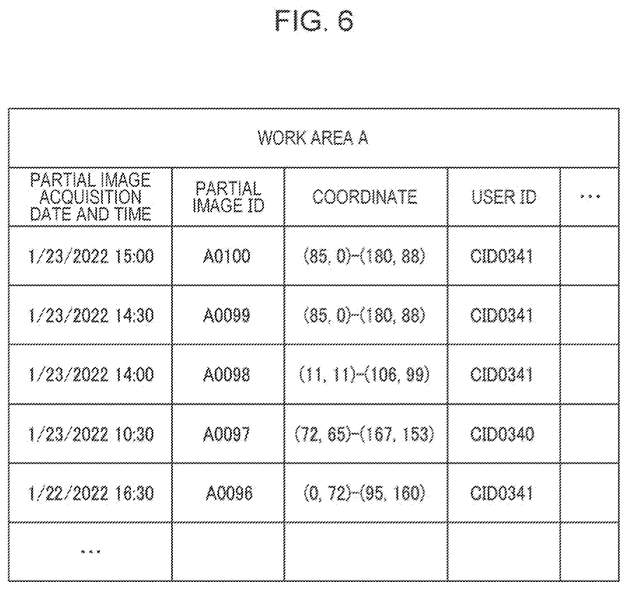

FIG. 6 is a table illustrating an example of identification information of the partial images 550 to which the present exemplary embodiment is applied.

FIG. 7 is a diagram illustrating an example of relationship between the whole image 540 and the partial images 550 to which the present exemplary embodiment is applied.

As illustrated in FIG. 6, even in the case where different user IDs are involved, the consolidated management is provided for the partial images 550 (see FIG. 7) acquired at the time of displaying one work area 600 on the operation screen 500 or the partial image generation information. In the case where one work area 600 is shared by a plurality of users, this enables the generation of the whole image 540 that shows the latest state of the one work area 600 in which the partial image 550 acquired by another user is utilized.

As illustrated in FIG. 7, the whole image 540 in the present exemplary embodiment is generated by combining the partial images 550 (550a to 550d) each showing the display area 610 displayed on one screen of the operation screen 500. In the whole image 540, for the sake of convenience, the area of each partial image 550 is indicated by dashed line. The partial image 550 is a so-called capture image and is image data showing the state of the display area 610 that is displayed on the operation screen 500 at a certain moment. In the example of FIG. 7, an area of the whole image 540 where no partial image 550 is incorporated is indicated by slanted line.

Next, the description is provided using a flowchart illustrated in FIG. 5.

First, the partial image acquisition part 103 illustrated in FIG. 4 acquires the partial image 550 based on the content of the determination made by the operation determination part 101 (step S701). In the present exemplary embodiment, in the case where an operation performed by a user, which is based on the content of the determination made by the operation determination part 101, satisfies a predetermined condition, the partial image acquisition part 103 acquires the partial image 550.

The partial image management part 104 manages, in each work area, the partial image 550 newly acquired by the partial image acquisition part 103 (step S702). In the present exemplary embodiment, the partial image management part 104 performs the management based on the date and time of acquisition of the partial image 550, the partial image ID of the partial image 550, the position information such as a coordinate in the work area 600 or the like, or the identification information such as the user ID of a user who acquired the partial image 550 or the like. In the case where a plurality of separate independent work areas 600 is maintained, the partial image management part 104 differentiates the work area 600 to which the display area 610 shown by the partial image 550 belongs. In the example of FIG. 6, in the work area 600 shared by a plurality of users, the partial image 550 acquired by another user who is different from a specific user is managed similarly as with the partial image 550 acquired by the specific user.

The area determination part 105 acquires the area size of the work area 600 to which the partial image 550 managed by the partial image management part 104 is added (step S703). The area determination part 105 sequentially checks the partial images 550 managed by the partial image management part 104 (step S704). In the present exemplary embodiment, the area determination part 105 starts checking from the partial image 550 having the latest date and time of acquisition. In the example of FIG. 6, first, the partial image ID “A0100” having the latest date and time of acquisition is checked.

The area determination part 105 determines, of the partial images 550 to be checked, whether or not the latest partial image 550 is in the inside of the acquired area size of the work area 600 (step S705). For example, the area determination part 105 determines that the partial image 550 having the coordinate outside the area of the latest work area 600 is not in the inside of the area size of the work area 600.

In step S705, when the latest partial image 550 is not in the inside of the acquired area size of the work area 600 (NO in step S705), the latest partial image 550 is not incorporated in the whole image 540, and the process proceeds to step S709.

In step S705, when the latest partial image 550 is in the inside of the acquired area size of the work area 600 (YES in step S705), the whole image generation part 106 reads out the latest partial image 550, which is determined by the area determination part 105 as being present in the area size, from the partial image storage part 108 and generate the whole image 540 that shows the entirety of the work area 600 (step S706). In the present exemplary embodiment, the whole image generation part 106 shows the state of the work area 600 by using the whole image 540 based on the coordinates of the partial images 550.

The whole image generation part 106 determines whether or not the partial image 550 is incorporated in every part of the whole image 540 (step S707).

In step S707, when the partial image 550 is incorporated in every part of the whole image 540 (YES in step S707), the whole image storage part 109 acquires the whole image 540 generated by the whole image generation part 106 and stores this generated whole image 540 as the latest whole image 540 (step S708), and the process ends.

In step S707, when the partial image 550 is not incorporated in every part of the whole image 540 (NO in step S707), the area determination part 105 determines whether or not there is another partial image 550 to be checked in the partial images 550 that are managed by the partial image management part 104 (step S709). For example, in the case where there are two or more partial images 550 that show the same area of the work area 600, the area determination part 105 does not check the partial image 550 whose date and time of acquisition is not the latest. In the example of FIG. 6, the partial image IDs “A0100 and A0099” have the same coordinate, and thus the next partial image 550 to be checked after the partial image ID “A0100” is the partial image ID “A0098”.

In step S709, when there is the next partial image 550 to be checked (YES in step S709), the area determination part 105 determines whether or not the next partial image 550 to be checked is in the inside of the acquired area size of the work area 600 (step S710).

In this step S710, when the next partial image 550 to be checked is not in the inside of the acquired area size of the work area 600 (NO in step S710), the process of determining whether or not there is another next partial image 550 is repeated (step S709).

In step S710, when the next partial image 550 to be checked is in the inside of the acquired area size of the work area 600 (YES in step S710), the whole image generation part 106 reads out the next partial image 550, which is determined by the area determination part 105 as being present in the inside of the area size, from the partial image storage part 108 and incorporates this next partial image 550 into the back side of the whole image 540 that shows the entirety of the work area 600 from which the area size is acquired (step S711). The present exemplary embodiment, the whole image generation part 106 incorporates the next partial image 550 into the back side of the whole image 540 in such a way that a specific partial image 550 is arranged on a upper layer (on the side toward the user's face) in display hierarchy than the next partial image 550 acquired prior to the specific partial image 550.

Here, a specific example of arrangement of the partial images 550 that form the whole image 540 is described.

In the example of FIG. 7, the whole image 540 is generated from four partial images 550 (550a to 550d). The partial image 550a corresponds to the partial image ID “A0100” of FIG. 6, and the partial images 550b to 550d correspond to the partial image IDs “A0098, A0097, A0096” of FIG. 6, respectively. The partial image 550a is incorporated into the whole image 540 prior to the partial images 550b to 550d and arranged on a upper layer (on the side toward the user's face) in display hierarchy. The next partial image 550b to be checked is arranged on a lower layer in the display hierarchy than the partial image 550a. In other words, the partial image 550b is arranged on the back side of the partial image 550a. Further, the partial image 550c is arranged on the back side of the partial image 550b, and the partial image 550d is arranged on the back side of the partial image 550c. This allows to generate the whole image 540 that shows the latest state of one work area 600.

Next, the whole image generation part 106 determines whether or not the partial image 550 is incorporated in every part of the whole image 540 (step S712).

In step S712, when the partial image 550 is incorporated in every part of the whole image 540 (YES in step S712), the whole image storage part 109 acquires the whole image 540 generated by the whole image generation part 106 and stores this generated whole image 540 as the latest whole image 540 (step S708), and the process ends.

In step S712, when the partial image 550 is not incorporated in every part of the whole image 540 (NO in step S712), the process of determining whether or not there is another next partial image 550 is repeated (step S709).

In step S709, when there is no next partial image 550 to be checked (NO in step S709), the whole image 540 is generated by using the background of the work area 600 in the area where no partial image 550 is incorporated (step S713), this generated whole image 540 is stored as the latest whole image 540 (step S708), and the process ends. In the example of FIG. 7, the background of the work area 600 is incorporated in the area of the whole image 540 where no partial image 550 is incorporated, which is indicated by slanted line.

According to the process steps described above, the process of generating the whole image 540 ends.

Acquisition of Partial Image 550 Using Mouse Operation

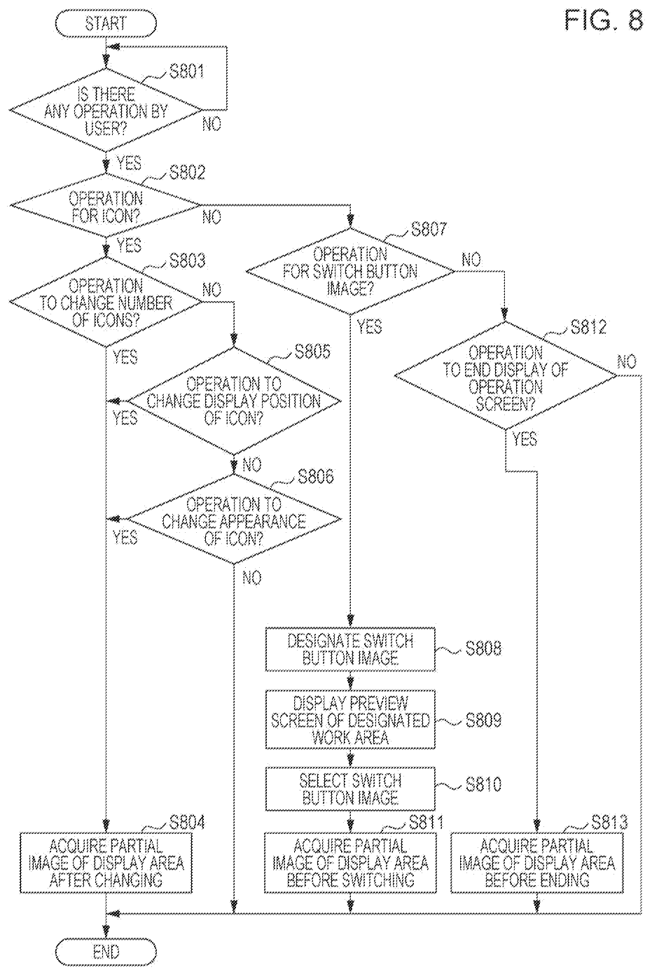

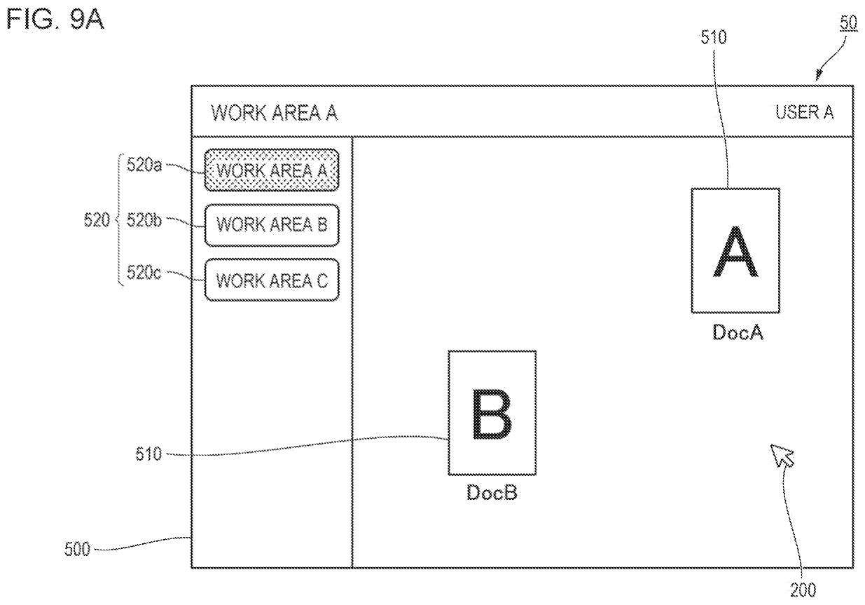

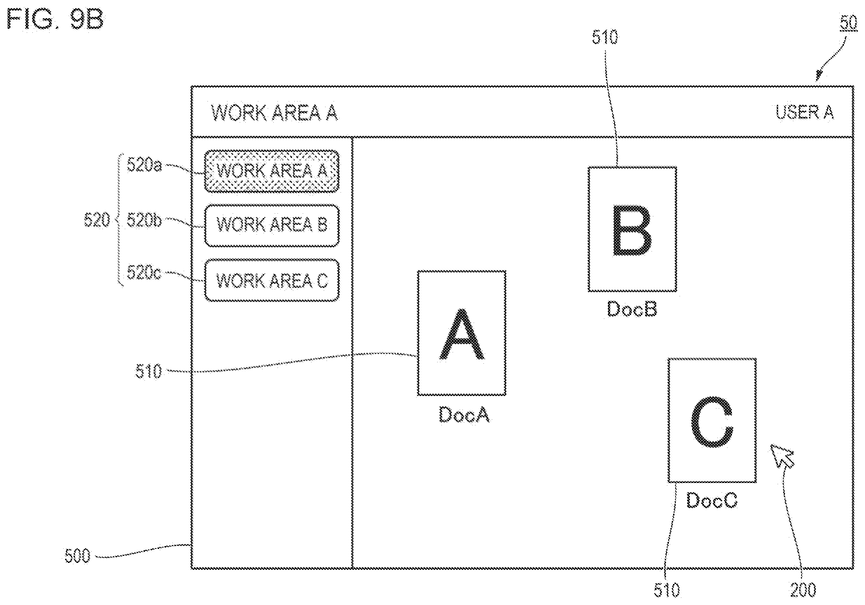

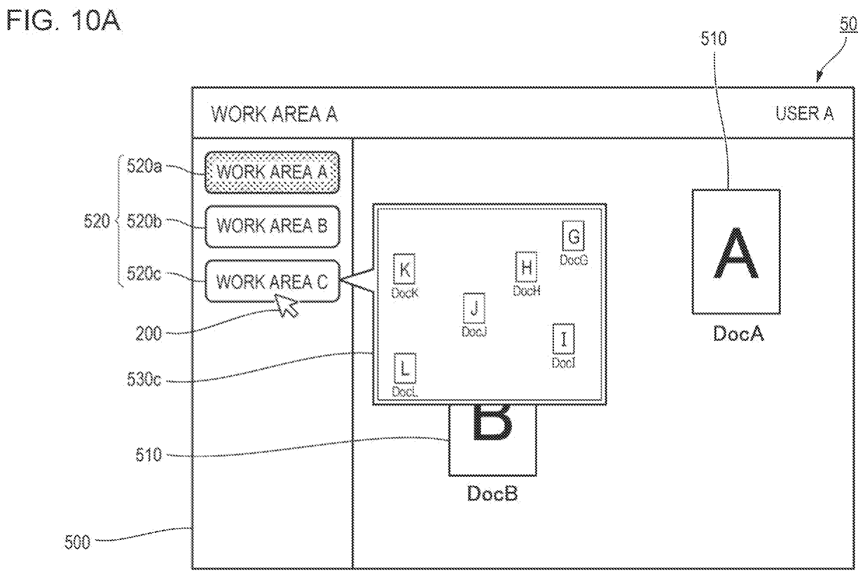

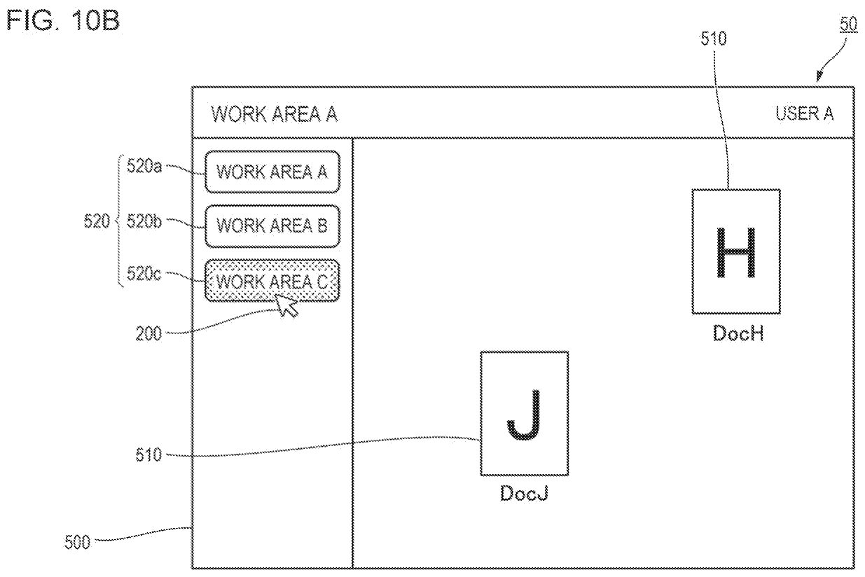

Next, a process of acquiring the partial image 550 based on a user operation is described using FIG. 4, FIG. 8, FIGS. 9A and 9B, and FIGS. 10A and 10B. Here, an example is described using a case where a user uses the input unit 20 such as a mouse or the like.

FIG. 8 is a flowchart illustrating process steps for acquiring the partial image 550 to which the present exemplary embodiment is applied.

FIGS. 9A and 9B and FIGS. 10A and 10B are diagrams each illustrating an example of display of the operation screen 500 to which the present exemplary embodiment is applied. FIG. 9A illustrates the state at the time before changing the display mode of the icons 510, and FIG. 9B illustrates the state at the time after changing the display mode of the icons 510. FIG. 10A illustrates the state where a preview screen 530c of a work area C is displayed in a work area A, and FIG. 10B illustrates the state where the work area C is displayed.

As illustrated in FIGS. 9A and 9B and FIGS. 10A and 10B, the display unit 50 in the present exemplary embodiment displays, on the operation screen 500, a cursor 200 that points a position, an image, or the like on the screen. The cursor 200 is displayed in such a manner as to move in response to an operation of a user, which is input via the input unit 20, and point a position, an image, or the like on the screen, which is designated by the user.

On the operation screen 500, the icons 510 and the switch button images 520 are displayed. The preview screen 530c illustrated in FIG. 10A is a screen illustrating the state of the entirety of the work area C.

Next, the description is provided using a flowchart illustrated in FIG. 8.

First, the operation determination part 101 illustrated in FIG. 4 determines whether or not there is an operation performed by a user on the operation screen 500 based on an operation via the input unit 20 (step S801). In the present exemplary embodiment, the operation determination part 101 determines that an operation with which a user gives an instruction in relation to the operation screen 500 is an operation performed by a user.

In step S801, when no operation is performed by a user (NO in step S801), waiting continues until a user performs an operation. When an operation is performed by a user (YES in step S801), the operation determination part 101 determines whether or not the operation performed by a user is an operation for the icon 510 (step S802). Operations for the icons 510 include, for example, an operation of changing the number of the icons 510, an operation of changing the display positions of the icons 510, or any similar operation, as is the case where the display mode of the icons 510 illustrated in FIG. 9A is changed to the display mode of the icons 510 illustrated in FIG. 9B.

In step S802, when the operation performed by a user is an operation for the icon 510 (YES in step S802), the operation determination part 101 determines whether or not the operation is an operation of changing the number of the icons 510 in the work area 600 (step S803). The operation determination part 101 determines that, for example, an operation of adding or deleting the icon 510 is an operation of changing the number of the icons 510.

In step S803, when the operation is an operation of changing the number of the icons 510 in the work area 600 (YES in step S803), the partial image acquisition part 103 acquires the partial image 550 showing the display area 610 after changing the number of the icons 510 (step S804), and the process ends.

In step S803, when the operation is not an operation of changing the number of the icons 510 in the work area 600 (NO in step S803), the operation determination part 101 determines whether or not the operation is an operation of changing the display position of the icon 510 in the work area 600 (step S805). The operation determination part 101 determines that, for example, an operation of moving the icon 510 by using drag-and-drop or the like is an operation of changing the display position of the icon 510.

In step S805, when the operation is an operation of changing the display position of the icon 510 in the work area 600 (YES in step S805), the partial image acquisition part 103 acquires the partial image 550 showing the display area 610 after changing the display position of the icon 510 (step S804), and the process ends.

In step S805, when the operation is not an operation of changing the display position of the icon 510 in the work area 600 (NO in step S805), the operation determination part 101 determines whether or not the operation is an operation of changing the appearance of the icon 510 in the work area 600 (step S806). The operation determination part 101 determines that, for example, an operation of changing the pictorial symbol of the icon 510, an operation of changing a document or a function name corresponding to the icon 510, and an operation of editing a document to be displayed as an thumbnail image are operations of changing the appearance of the icon 510.

In this step S806, when the operation is an operation of changing the appearance of the icon 510 in the work area 600 (YES in step S806), the partial image acquisition part 103 acquires the partial image 550 showing the display area 610 after changing the appearance of the icon 510 (step S804), and the process ends.

In step S806, when the operation is not an operation of changing the appearance of the icon 510 in the work area 600 (NO in step S806), the process ends without acquiring any partial image 550.

In step S802, when the operation performed by a user is not an operation for the icon 510 (NO in step S802), the operation determination part 101 determines whether or not the operation is an operation for the switch button image 520 (step S807). The operation determination part 101 in the present exemplary embodiment determines that, for example, an mouseover operation and a clicking operation on the switch button image 520 are operations for the switch button image 520.

In step S807, when the operation performed by a user is an operation for the switch button image 520 (YES in step S807), the operation determination part 101 determines that the switch button image 520 is designated (step S808). In the present exemplary embodiment, the operation determination part 101 determines that an mouseover operation on the switch button image 520 is a designation of the switch button image 520.

The preview screen output part 107 outputs the preview screen 530 of the work area corresponding to the designated switch button image 520 and displays this preview screen 530 on the operation screen 500 (step S809). In the example of FIG. 10A, the switch button image 520c is designated, and the preview screen 530c of the work area C that corresponds to the switch button image 520c is displayed.

Next, the operation determination part 101 determines that the switch button image 520 is selected (step S810). In the present exemplary embodiment, the operation determination part 101 determines that a clicking operation on the switch button image 520c is a selection of the switch button image 520. In the example of FIG. 10B, the switch button image 520c is selected, and part of the work area 600 of the work area C that corresponds to the switch button image 520c is displayed on the operation screen 500.

The partial image acquisition part 103 acquires the partial area 550 showing the display area 610 before switching the work area 600 displayed on the operation screen 500 (step S811), and the process ends.

In step S807, when the operation performed by a user is not an operation for the switch button image 520 (NO in step S807), the operation determination part 101 determines whether or not the operation is an operation of ending the display of the operation screen 500 (step S812). The operation determination part 101 determines that, for example, a clicking operation on a stop button image that receives an operation of ending the display of the operation screen 500 and a key inputting operation that ends the display of the operation screen 500 are operations of ending the display of the operation screen 500. Here, the stop button image is not illustrated.

In this step S812, when the operation performed by a user is an operation of ending the display of the operation screen 500 (YES in step S812), the partial image acquisition part 103 acquires the partial image 550 showing the display area 610 before ending the display of the operation screen 500 (step S813), and the process ends.

In step S812, when the operation performed by a user is not an operation of ending the display of the operation screen 500 (NO in step S812), the process ends without acquiring any partial image 550.

In the examples described above, the partial images 550 are acquired when a user simply performs the predetermined operation. However, the present exemplary embodiment is not limited thereto. For example, the partial image 550 may be acquired when a predetermined time has elapsed from the time a user performed a predetermined operation. This allows to avoid the acquisition of an unnecessary partial image 550.

Display Mode of Preview Screen 530

In the examples described above, the preview screen 530 is displayed in such a manner as to simply show the entirety of the work area 600. However, the present exemplary embodiment is not limited thereto. Alternatively, the preview screen 530 may not display the entirety of the work area 600.

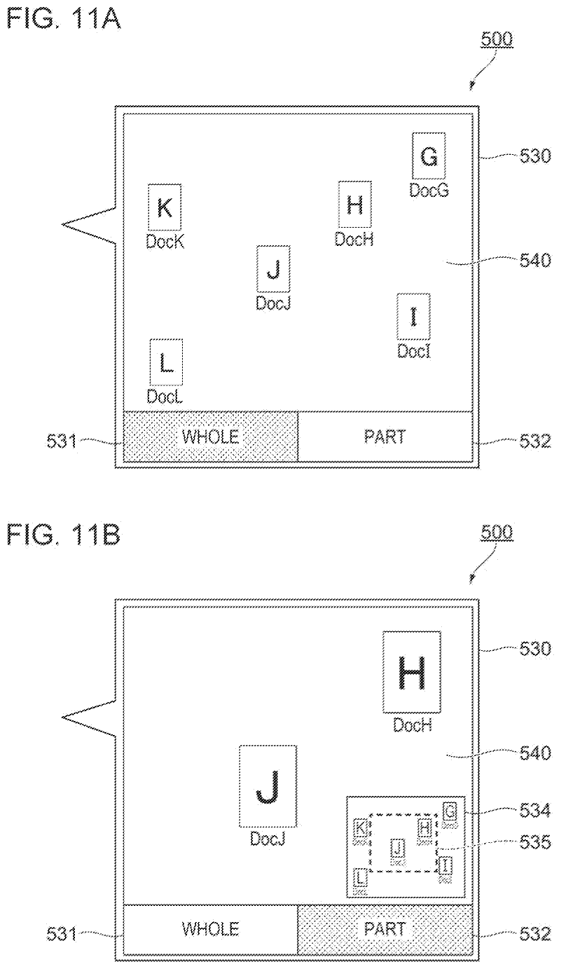

As examples of such display, display modes in each of which at least part of the work area 600 is displayed on the preview screen 530 are described using FIGS. 11A and 11B.

FIG. 11A is a diagram illustrating an example of the preview screen 530 to which the present exemplary embodiment is applied, the example illustrating the state where the whole image 540 is displayed on one screen, and FIG. 11B is a diagram illustrating an example of the preview screen 530 to which the present exemplary embodiment is applied, the example illustrating the state where an enlarged whole image 540 is displayed.

Each of the preview screens 530 illustrated in FIGS. 11A and 11B includes a whole display button image 531 and a part display button image 532 for receiving, from a user, an operation to select “the display of the entirety of the work area 600” or “the display of a partial area of an enlarged work area 600”.

As illustrated in FIG. 11A, when the whole display button image 531 is selected, the whole image 540 is displayed in such a manner as to display the entirety of the work area 600.

As illustrated in FIG. 11B, when the part display button image 532 is selected, the whole image 540 is enlarged and displayed in such a way that part of the work area 600 is shown. Alternatively, the preview screen 530 may display a reduced whole image 534 that shows the entirety of the work area 600 and a display range frame 535 that shows “which area is enlarged and displayed”. Furthermore, the preview screen 530 may receive, from a user, an operation of moving the area to be enlarged and displayed. Operations of moving the area to be displayed include a scrolling operation using the input unit 20 such as a mouse or the like and an operation of sliding a finger or the like while maintaining contact with the display unit 50 such as a touch panel or the like.

The magnification to be used for enlarging the whole image 540 in such a manner as to show part of the work area 600 may be changed based on an operation by a user. Operations of changing the magnification include, for example, an operation of re-selecting the part display button image 532, a key operation or a mouse operation while keeping the cursor 200 on the preview screen 530, and an operation of selecting an magnification change button image that receives an operation of changing the magnification. Here, the magnification change button image is not illustrated.

Furthermore, in the case where the switch button image 520 corresponding to the work area 600 being displayed on the preview screen 530 is selected while a user is selecting the part display button image 532 on the preview screen 530, the area being displayed on the preview screen 530 may be displayed on the operation screen 500 as the display area 610. In other words, the area surrounded by the display range frame 535 becomes the display area 610.

In the examples described above, the preview screen 530 simply displays the whole image 540. However, the present exemplary embodiment is not limited thereto. The preview screen 530 may make a notification of changing the display mode of icon 510 using a pictorial symbol or texts. This notification may also indicate details of the content of the change such as addition or deletion of the icon 510, edition of a file corresponding to the icon 510, and the like. This allows a user to check the latest state of the entire work area even in the case where there isn't the whole image 540 reflecting the latest state of the entire work area.

The process to be performed by the image display apparatus 1 in the present exemplary embodiment is prepared, for example, as a program such as application software or the like. This program may be provided by communications or using a recording medium such as a CD-ROM or the like in which the program is stored.

Note that with regard to the present application, the disclosure may also be perceived in the following manners.

An information processing apparatus to which the present disclosure is applied may include a processor configured to: display, on an operation screen for receiving an operation performed by a user, at least part of a work area in which an instruction image that receives an instruction from a user is placed; acquire at least one of a partial image and partial image generation information, the partial image showing an area of the work area to be displayed on one screen of the operation screen, the partial image generation information distinguishing each of the partial images; manage, in each work area, at least one of the acquired partial image and the acquired partial image generation information; generate a whole image that shows an entirety of the work area by combining the partial images based on the partial image or the partial image generation information; and display the whole image to allow a user to check a state of the work area.

Here, the processor may be configured to newly generate the whole image every time the partial image is acquired.

The processor may be configured to utilize the partial image acquired by another user or the partial image generation information when the work area is shared by a plurality of users.

The processor may be configured to acquire the partial image when the operation performed by a user satisfies a predetermined condition.

The processor may be configured to acquire the partial image when the operation performed by a user is an operation of changing a display mode of the instruction image.

The processor may be configured to acquire the partial image when the operation performed by a user is an operation of stopping a display of the work area being displayed in the operation screen.

A program to which the present disclosure is applied may cause a computer to implement: a function to display, on an operation screen for receiving an operation performed by a user, at least part of a work area in which an instruction image that receives an instruction from a user is placed; a function to acquire at least one of a partial image and partial image generation information, the partial image showing an area of the work area to be displayed on one screen of the operation screen, the partial image generation information distinguishing each of the partial images; a function to manage, in each work area, at least one of the acquired partial image and the acquired partial image generation information; a function to generate a whole image that shows an entirety of the work area by combining the partial images based on the partial image or the partial image generation information; and a function to display the whole image to allow a user to check a state of the work area.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
maintain a work area in which an instruction image that receives an instruction from a user is placed, the work area being an area larger than an area to be displayed on an operation screen for receiving an operation performed by a user; and
when a specific work area is designated, display a whole image that shows an entirety of the specific work area on the operation screen.

2. The information processing apparatus according to claim 1, wherein the processor is configured to:
generate the whole image by combining partial images each showing an area of the work area to be displayed on one screen of the operation screen.

3. The information processing apparatus according to claim 2, wherein the processor is configured to:
newly generate the whole image when the partial image is acquired.

4. The information processing apparatus according to claim 2, wherein the processor is configured to:
acquire the partial image when the operation performed by a user satisfies a predetermined condition.

5. The information processing apparatus according to claim 4, wherein the processor is configured to:
acquire the partial image when the operation performed by a user is an operation of changing a display mode of the instruction image.

6. The information processing apparatus according to claim 4, wherein the processor is configured to:
acquire the partial image when the operation performed by a user is an operation of stopping a display of the work area being displayed on the operation screen.

7. The information processing apparatus according to claim 2, wherein the processor is configured to:
generate the partial image from partial image generation information that distinguishes each of the partial images.

8. The information processing apparatus according to claim 2, wherein the processor is configured to:
utilize the partial image acquired by another user or partial image generation information that distinguishes each of the partial images when the work area is shared by a plurality of users.

9. The information processing apparatus according to claim 7, wherein the processor is configured to:
utilize the partial image acquired by another user or partial image generation information that distinguishes each of the partial images when the work area is shared by a plurality of users.

10. A non-transitory computer readable medium storing a program causing a computer to execute a process, the process comprising:
maintaining a work area in which an instruction image that receives an instruction from a user is placed, the work area being an area larger than an area to be displayed on an operation screen for receiving an operation performed by a user; and
when a specific work area is designated, displaying a whole image that shows an entirety of the specific work area on the operation screen.

11. An information processing method comprising:
maintaining a work area in which an instruction image that receives an instruction from a user is placed, the work area being an area larger than an area to be displayed on an operation screen for receiving an operation performed by a user; and
when a specific work area is designated, displaying a whole image that shows an entirety of the specific work area on the operation screen.
